(19) United States
(12) Patent Application Publication
(10) Pub. No.: US 2015/0205285 A1
(43) Pub. Date: Jul. 23, 2015

(54) Robot, Robot Control Method and Robot Control Program

(71) Applicant: JANOME SEWING MACHINE CO., LTD., Tokyo (JP)

(72) Inventor: Kenichiro HIRUMA, Tokyo (JP)

(21) Appl. No.: 14/578,918

(22) Filed: Dec. 22, 2014

(30) Foreign Application Priority Data
Jan. 17, 2014 (JP) 2014-007217

(51) Int. Cl. G05B 19/19; B25J 9/16

(52) U.S. Cl. CPC G05B 19/19; B25J 9/16; G05B 2219/50391; Y10S 901/41

(57) ABSTRACT

A robot of this embodiment moves a work tool to points where multiple work-pieces are placed, and executes a process specified at the point where each work-piece is placed. A point-coordinate memory stores a position of the point where the work-piece is placed. A first work-instruction-sequence memory stores a first work instruction executed at the point where the work-piece is placed. A second work-instruction-sequence memory stores a second work instruction executed at the point where the work-piece is placed. A controller moves the work tool to a position stored in a point-sequence memory, and causes the work tool to execute the first and second work instructions.

### CROSS-REFERENCE TO RELATED APPLICATIONS

This application is based upon and claims the benefit of priority from Japan Patent Application No. 2014-007217, filed on Jan. 17, 2014, the entire contents of which are incorporated herein by reference.

### BACKGROUND OF THE INVENTION

1. Field of the Invention

The present disclosure relates to a robot control method for causing the robot to execute multiple stored work instructions at a predetermined position generally called a point, a robot utilizing the same, and an operation setting program for controlling the operation of the robot.

2. Description of the Related Art

In general, according to programs for controlling the operation of a robot, an instruction-based method to the robot for causing the robot to execute an arbitrary operation, and a process-based method at a point where the robot is actuated are known. According to a process-based robot at a point, the robot is caused to execute an arbitrary process at a predetermined position called a point.

For example, to cause a process-based robot at a point to execute two kinds of works, such as a tentative insertion work and a final tightening work at an arbitrary point, it is necessary to set a tentative insertion work as the work at that point, and to set the final tightening work at the same point. That is, it is necessary to recognize, as different points, the same coordinates and to set the tentative insertion work and the final tightening work to the respective coordinates.

### CITATION LIST

### Patent Literatures

Patent Document 1: JP 2007-193846 A

According to such robots, as illustrated in FIG. 12, when the tentative insertion work and the final tightening work are executed at positions of points 1 to 8, it is necessary to set the following (a) to (d) items.

(a) Set respective X, Y, and Z coordinates of the points 1 to 8 where the tentative insertion work is executed.

(b) Set “tentative insertion work” as “point work” executed at the points 1 to 8.

(c) Set respective X, Y, and Z coordinates of the points 1 to 8 where the tentative insertion work is executed as points 9 to 16 where the final tightening work is executed.

(d) Set “final tightening work” as “point work” executed at the points 9 to 16.

When the above-explained items (a) to (d) are set, it becomes possible to execute the “tentative insertion work” and the “final tightening work” to a target work-piece at the points 1 to 8.

As an example setting of a point sequence, first, the “tentative insertion work” is set at each point, and then the “final tightening work” is set at each point. As illustrated in FIG. 13, as the setting of the “tentative insertion work”, a number “1” is set as the “point work number” at the points 1 to 8. The “point work number” is a number indicating the work instruction sequence executed at the point, and the set number is referred to execute the work instruction sequence indicated by the number. Likewise, as to the points 2 to 8, the number “1” is set as the “point work number”.

Next, the points having the same X, Y, and Z coordinates as those of the points 1 to 8, respectively, are set as the points 9 to 16, and the “final tightening work” is set. As the “point work number” executed at the points 9 to 16, a number “2” is set.

As explained above, according to a conventional teaching of point-based robots, it is difficult to set two point works at the same point. Hence, when two kinds of works that are the tentative insertion work and the final tightening work are set at the same point, as explained above, it is necessary to recognize, as different points, a point indicated by the same coordinate, and to set the tentative insertion work and the final tightening work at the respective points. As explained above, although those are the works executed at the point indicated by the same coordinate, the points are treated as different points. Therefore, it is necessary to make similar settings to both points at the time of teaching, which is bothersome and often causes mistakes.

In addition, when the two works are relevant, and when, for example, with reference to data obtained as a result of a first work (works at the points 1 to 8), a second work (works at the points 9 to 16) is executed, in order to associate such data, it is necessary to give some explicit instruction. For example, as illustrated in FIG. 14, as a first work at a given point, a work “to execute a tentative insertion work, and to input a driver rotation angle when stopped in a variable rot [tagNumber] ” is executed. Next, as a second work, a work “to read the rotation angle from rot [tagNumber], and set the driver to this angle before a final tightening work is executed” is executed. In this case, it is necessary to inform the second-work side referring to the variable array rot [tagNumber] of where the driver rotation angle that is the result of the first work is stored in the variable array rot [tagNumber] and to indicate that location. However, such a work is bothersome and often causes a mistake.

The present disclosure has been proposed to address the aforementioned problems of the conventional technologies, and enables a setting of two works that are a first work and a second work as works at a point. Hence, it becomes possible to provide a robot, a robot control method, and a robot control program can be provided which simplifies a teaching, and which prevents a human error.

### SUMMARY OF THE INVENTION

To accomplish the above objective, according to an aspect of the present disclosure, a robot that moves a work tool to a predetermined point, and executes a process specified at the point, and the robot includes: a point position memory storing a position of the point; a first work-instruction-sequence memory storing a first work instruction executed at the point; a second work-instruction-sequence memory storing a second work instruction executed at the point; and a controller moving the work tool to a position stored in the point position memory, and causing the work tool to execute the first work instruction and the second work instruction.

In addition, a control method for a robot which moves a work tool to points where multiple work-pieces are placed and which executes a specified process at the point where each work-piece is placed, and a control program for the same are also aspects of the present disclosure.

### BRIEF DESCRIPTION OF THE DRAWINGS

FIG. 1 is a perspective view illustrating a whole structure of a robot according to a first embodiment of the present disclosure;

FIG. 2 is a functional block diagram of a control device according to the first embodiment of the present disclosure;

FIG. 3 is a block diagram illustrating a structure of a point-sequence memory according to the first embodiment of the present disclosure;

FIG. 4 is a diagram illustrating a work content stored in a work-instruction-sequence memory according to the first embodiment of the present disclosure;

FIG. 5 is a diagram illustrating a point number stored in the work-instruction-sequence memory according to the first embodiment of the present disclosure;

FIG. 6 is a diagram illustrating an example way of storing by the point-sequence memory according to the first embodiment of the present disclosure;

FIG. 7 is a flowchart illustrating an operation of a robot to multiple work-pieces according to the first embodiment of the present disclosure;

FIG. 8 is a diagram illustrating a work content stored in the work-instruction-sequence memory when a correction level of a position is referred and a work tool is moved according to the first embodiment of the present disclosure;

FIG. 9 is a diagram illustrating a work content stored in the work-instruction-sequence memory when a return point is set to execute a second work after the completion of a first work according to another embodiment of the present disclosure;

FIG. 10 is a flowchart illustrating an operation of a robot when a return point is set to execute the second work after the completion of the first work;

FIG. 11 is a diagram illustrating a detail of a setting when a point kind is defined in the work-instruction-sequence memory according to another embodiment of the present disclosure;

FIG. 12 is a diagram illustrating a screw tightening work by a conventional robot;

FIG. 13 is a diagram illustrating a work instruction sequence of a conventional robot; and

FIG. 14 is a diagram illustrating a point work instruction of a conventional robot and an array variable thereof.

### DETAILED DESCRIPTION OF THE PREFERRED EMBODIMENTS

A robot according to embodiments of the present disclosure will be explained below in detail with reference to the accompanying drawings. In the embodiments, the duplicated explanation for the drawings will be omitted.

### [1. First Embodiment]

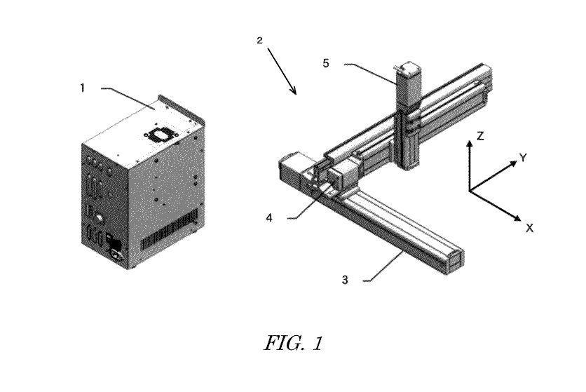

FIG. 1 is a diagram illustrating a whole structure of a robot according to this embodiment. The robot of this embodiment mainly includes two parts as illustrated in FIG. 1. The one is a controller 1, and the other is a main unit 2. The main unit 2 includes an X slider 3 movable in an X direction, a Y slider 4 mounted on a portion movable in a Y direction, and a Z slider 5 attached to a portion movable in a Z direction. A work tool (unillustrated) is attached to a portion of the Z slider 5 movable in the Z direction. Each slider is actuated by a motor, and when the motor is actuated in accordance with an instruction from the controller 1, the work tool can be moved in the X, Y, and Z directions.

According to the robot of this embodiment, when a tentative insertion work and a final tightening work are executed at points 1 to 8, it is necessary to set the following items (a) and (b).

(a) Set respective X, Y, and Z coordinates of the points 1 to 8 where the tentative insertion work is executed.

(b) Set “tentative insertion work” as a first work at the points 1 to 8 and “final tightening work” as a second work.

When the above-explained (a) and (b) are set, the “tentative insertion work” and the “final tightening work” can be executed at the points 1 to 8 where a target work-piece is placed.

According to such a robot control, the work tool is moved in accordance with the order of points set through a teaching, and the first work and the second work defined as point kinds at each point are executed. In addition, when the second work is executed, the result of the first work is reflected thereon.

### [1-1. Structure]

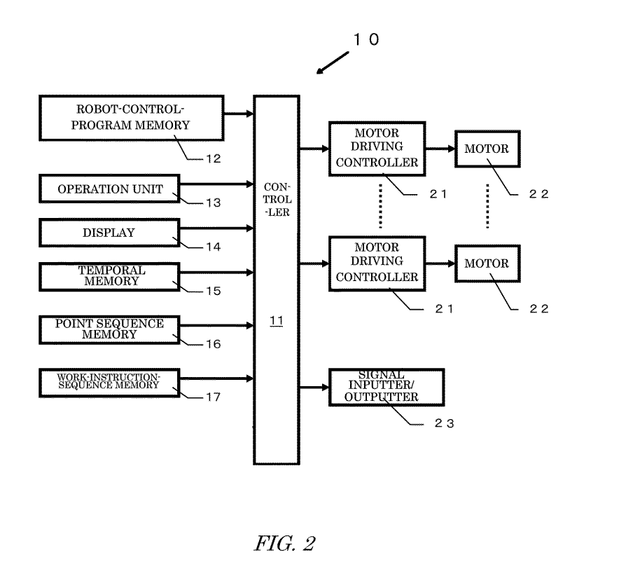

A control device 10 is built in the controller 1. FIG. 2 is a functional block diagram of the control device 10. In FIG. 2, a controller (CPU) 11 mainly including a microcomputer controls the overall robot. The controller 11 executes, in accordance with a control program stored in a robot-control-program memory 12, an input operation, a display, a storing, a motor actuation, and a signal input and signal output. The robot includes an operation unit 13, a display 14, a temporal memory 15, a point-sequence memory 16, and a work-instruction-sequence memory 17. The temporal memory 15 is utilized for such a control operation.

The controller 11 outputs an instruction to a motor driving controller 21 to actuate a motor 22, thereby executing various operations. The number of motor driving controllers 21 and that of the motors 22 are set at an arbitrary number as needed. The motor 22 is connected to a work tool executing a work and an operation by drive force from the motor 22.

In the case of, for example, a screw tightening work tool, four motors including, in addition to an X-axis-direction movable motor, a Y-axis-direction movable motor, and a Z-axis-direction movable motor moving the screw tightening work tool to a predetermined point, a screw tightening motor to rotate the screw tightening tool performs a control. In addition, the controller 11 outputs an instruction to a signal inputter/outputter 23 to input a signal from the exterior or to output a signal thereto. The signal input from the exterior is reflected on a control to the robot, and an external device is controlled based on a signal to the exterior.

The operation unit 13 includes an input device like a keyboard, and hardware and software resources for teaching, and inputs a program and data of the robot. In addition, the display 14 includes an LCD display device, and displays a set value and an input condition through the operation unit 13.

The temporal memory 15 is a so-called memory, and temporary stores necessary information when the controller 11 outputs a control instruction.

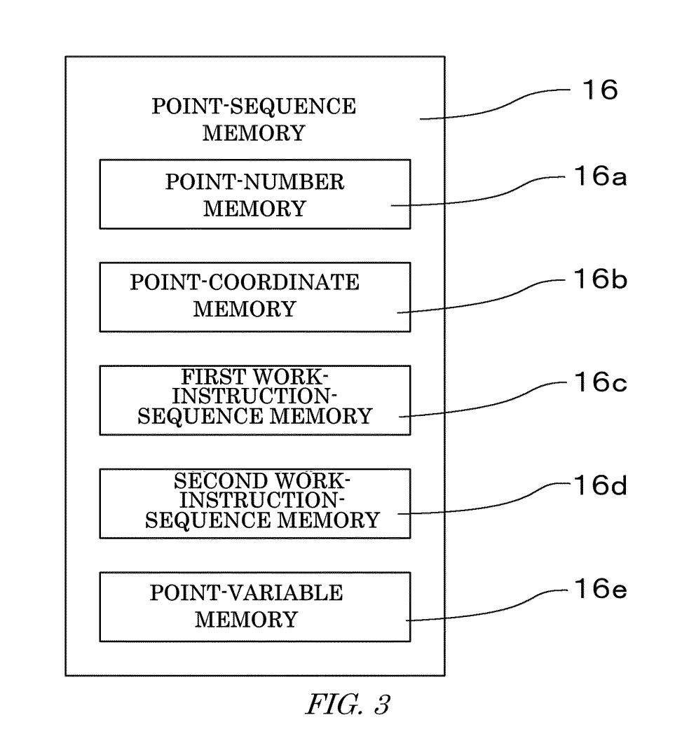

The point-sequence memory 16 stores a point where the work tool is moved, the first work and the second work executed at this point. In addition, the point-sequence memory 16 includes a memory area that temporarily stores a result of the first work at this point. As illustrated in FIG. 3, the point-sequence memory 16 includes a point-number memory 16a, a point-coordinate memory 16b, a first work-instruction-sequence memory 16c, a second work-instruction-sequence memory 16d, and a point-variable memory 16e.

The point-number memory 16a stores a point number given to the point where the robot executes a work. According to a point-based robot, in accordance with a content of the teaching set in the point-sequence memory 16, the work tool is controlled. The point number is given to the point where the work tool is controlled, and the robot executes the instruction in an order of a smaller point number. The point-coordinate memory 16b stores X, Y, and Z coordinates of the point where the robot executes a point work. The point-coordinate memory 16b corresponds to a point-position memory.

The first work-instruction-sequence memory 16c stores a work-instruction sequence to execute the first work at the point. The second work-instruction-sequence memory 16d stores a work-instruction sequence to execute the second work at the point. The work-instruction sequences stored in the first and second work-instruction-sequence memories 16c, 16d are stored as a number indicating the detail of the work-instruction sequence. The point-variable memory 16e stores, as a variable at the point, a variable obtained upon execution of the first work. When the second work is executed at this point, this variable is read and is reflected on the second work.

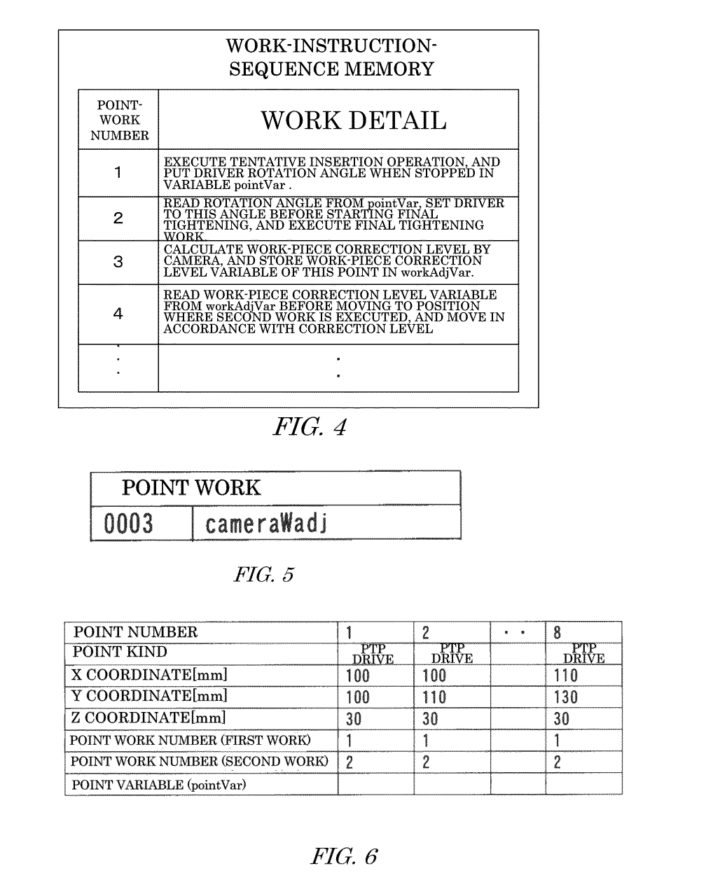

The work-instruction-sequence memory 17 stores a work-instruction sequence to cause the work tool to execute a work. As to the work-instruction sequence, a number indicating this work-instruction sequence is stored as a point-work number. The work instruction is an instruction ordering the robot to execute a work operation, and includes instructions for various works, such as screw tightening, painting, and soldering. As to the work instruction, work instructions executed at multiple timing, such as before the work tool moves to a point, while the work tool is moving to the point, and after the work tool reaches the point, are set and stored. FIG. 4 is a diagram illustrating an example work-instruction sequence stored in the work-instruction-sequence memory 17. The work-instruction-sequence in FIG. 4 is stored in association with the point-work number.

As illustrated in FIG. 4, a work-instruction sequence of “executing a tentative insertion work, and putting a driver rotation angle when stopped in a variable pointVar” is stored. As a point-work number corresponding to this work-instruction sequence, “1” is set. That is, prior to a teaching, when a point number to execute the first work and the second work is set as “1”, the robot executes an operation of “executing the tentative insertion work, and putting the driver rotation angle when stopped in the variable pointVar”.

Likewise, a work-instruction sequence of “reading the rotation angle from pointVar, and setting the driver to this angle before starting a final tightening” is stored. As a point-work number for this work-instruction sequence, “2” is associated.

As a point-work number “3”, a work-instruction sequence of “calculating a work-piece correction level by a camera, and storing a work-piece correction level variable at this point in workAdjVar” is stored in association with the number. As a point-work number “4”, a work-instruction sequence of “reading a work-piece correction level variable from workAdjVar when moving to a position where the second work is executed, and moving in accordance with the correction level” is stored in association with the number.

The work-instruction sequence stored in the work-instruction-sequence memory 17 may have the detail of the work stored in association with the point number, and the instruction sequence may be stored as a command. That is, as illustrated in FIG. 5, a work-instruction sequence corresponding to the point-work number “3” may be stored as a command that is “cameraWadj”.

### [1-2. Operation]

According to this embodiment, as a teaching at each point, two works that are the first work and the second work are set. Hence, in accordance with the arrangement of the points, first, the first work is executed, and then the second work is executed. In addition, result data of the first work is stored as data at the point, and the second work is executed while referring to the data stored in this point.

According to the robot of this embodiment, when a work process is executed while performing a correction on multiple work-pieces placed at the positions of the points 1 to 8, as illustrated in FIG. 6, it is necessary to set the following items (a) and (b) in the point-sequence memory 16.

(a) Set respective X, Y, and Z coordinates of the points 1 to 8 where the “tentative insertion work” and the “final tightening work” are executed.

(b) Set, in the points 1 to 8, the “tentative insertion work” as a first “point work” and the “final tightening work” as a second “point work”.

When the above-explained (a) and (b) are set, the “tentative insertion work” and the “final tightening work” can be executed at the points 1 to 8 where the target work-pieces are placed.

As illustrated in FIG. 6, when the two point works are executed at the point numbers 1 to 8, first, respective X, Y, and Z coordinates of the point numbers 1 to 8 are set. In FIG. 6, the location of the work-piece placed at the point number 1 is indicated as (100, 100, 30) in (X, Y, Z) coordinates, the location of the work-piece placed at the point number 2 is indicated as (100, 110, 30) in the (X, Y, Z) coordinates, and the location of the work-piece placed at the point number 8 is indicated as (100, 130, 30) in the (X, Y, Z) coordinates. Such a setting is made for the locations of the work-pieces placed at the points 1 to 8.

Next, a work-instruction sequence to execute the first work at the points 1 to 8 is set with the point-work number. In FIG. 6, as the point-work number of the first work executed at the point 1, “1” is set. The work-instruction sequence indicated by the point-work number “1” is to cause the robot to execute a work of “executing a tentative insertion operation, and putting the driver rotation angle when stopped in the variable pointVer”. The variable pointVer is a variable stored in the memory for each point. Hence, the variable obtained upon execution of the work-instruction sequence indicated by the point-work number is stored as a data value at the point. Likewise, as the point-work number of the first work at the points 2 to 8, “1” is set.

Next, the work-instruction sequence to execute the second work at the points 1 to 8 is set with the point-work number. In FIG. 6, as the point-work number of the second work executed at the point 1, “2” is set. The work-instruction sequence indicated by the point-work number “2” is to cause the robot to execute a work of “reading the rotation angle from pointVer, and setting the driver to this angle before starting a final tightening”. As explained above, the variable pointVer is a variable stored in the memory for each point. Hence, it is unnecessary to specify, in the work-instruction sequence indicated by the point-work number “2”, where the variable pointVer is stored.

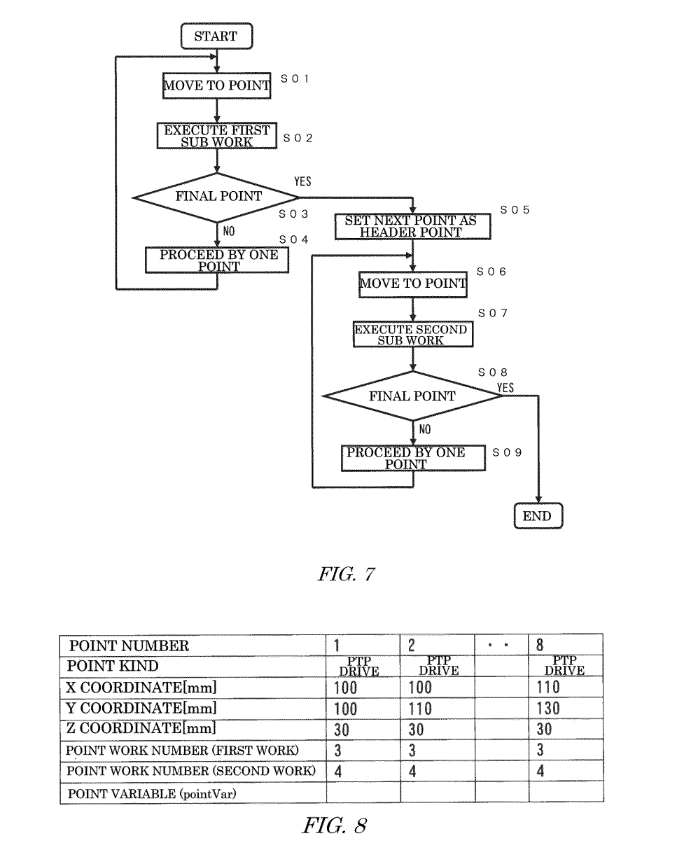

In the following explanation, a control flow for the robot in accordance with the detail stored in the point-sequence memory illustrated in FIG. 6 will be explained. As illustrated in FIG. 7, first, the robot moves (STEP 01) the work tool to the coordinate set with the point number 1. Next, the robot causes the work tool to execute the first work in accordance with the work-instruction sequence indicated by the point-work number set at the point 1 (STEP 02).

After the first work at the point 1, it is determined (STEP 03) whether or not the point 1 is a final point of the work. When the point 1 is not the final point of the work (STEP 03: NO), the process forwards by one point (STEP 04). Next, the work tool is moved to the coordinate set at the point 2, and the work tool is caused to execute the first work in accordance with the work-instruction sequence indicated by the point-work number set at the point 2. This process is repeated until the point where the work tool is caused to execute the first work becomes the final point.

Next, like the point 8 in FIG. 6, when the point where the first work is executed is the final point (STEP 03: YES), the point where the second work is executed is set as a header point. That is, after the first work at the point 8 is executed, the point where the second work is executed is set as the point 1 (STEP 05).

Next, the work tool is moved in accordance with the coordinate set at the point 1, and the work tool is caused to execute the second work in accordance with the work-instruction sequence indicated by the point-work number set at the point 1. This process is repeated until the point where the second work is executed by the work tool becomes the final point (STEPS 06 to 09).

Next, like the point 8 in FIG. 6, when the point where the second work is executed becomes the final point (STEP 08: YES), a robot control is finished.

### [1-3. Advantageous Effects]

According to a teaching of the robot of this embodiment as explained above, as a teaching at a given point, two works that are the first work and the second work can be set. Hence, according to the robot of this embodiment, based on a teaching at one point, the first work is executed, and then the second work is executed. Hence, the number of steps of teaching can be reduced, which simplifies the teaching. Therefore, a human error like false inputting can be prevented.

In addition, according to this embodiment, the variable memory that stores a variable obtained upon execution of the first work is provided, and when the second work is executed, an instruction reflecting the variable is executed. Accordingly, when the second work instruction is executed based on the result of the first work, it is unnecessary to set a memory area from which the first work result is read. Therefore, the teaching can be simplified.

Still further, according to this embodiment, a data value indicating a correction level of a position is set as the variable, and when the second work is executed, the correction level of this position is read to move the work tool. As illustrated in FIG. 8, as the point-work number indicating the first work, “3” is set, and as the point-work number indicating the second work, “4” is set.

The work-instruction sequence indicated by the point-work number “3” causes the robot to execute a work of “calculating a work-piece correction level by a camera, and storing the work-piece correction level variable at this point in workAdjVar”. The variable workAdjVar is a variable stored in a memory for each point, and stored as a correction level at each point. The actual work-piece correction level is not merely a single numerical value, but is a combination of multiple numerical values, such as a rotation, a parallel movement (X direction), and a parallel movement (Y direction). This combination is stored as the variable workAdjVar.

The work-instruction sequence indicated by the point-work number “4” causes the robot to execute a work of “reading the work-piece correction level variable from workadjVar when moving to the position where the second work is executed, and moving in accordance with the correction level”. This correction movement is not performed based on the work-instruction sequence set with a point number, but may be performed by a control program stored in the robot-control-program memory 12. When the second work is executed, the work tool may be moved after the coordinates of the destination are converted into a correction level. In this case, the variable workAdjVar is stored in a memory for each point. Hence, when the second work is executed at a given point, it is fine if the variable workAdjVar stored for this point is utilized, and an explicit indication is unnecessary.

Hence, a teaching of actuating the work tool in accordance with the position correction level becomes easy.

### [2. Other Embodiments]

The embodiment of the present disclosure was explained above, but various omissions, replacements, and modifications can be carried out without departing from the scope of the present disclosure. Such embodiments and modified examples thereof should be within the scope of the present disclosure, and also within the subject matter as recited in the appended claims and the equivalent range thereto.

(a) For example, in the illustrated embodiment, the first work instruction and the second work instruction are defined as commands representing a point number and an instruction sequence, but it is also possible to specify an instruction by directly inputting a statement to execute those instructions.

(b) The point-sequence memory 16 may be a combination of a volatile memory and a non-volatile memory in accordance with an item to be stored. That is, the point number, and the point coordinates are stored in a non-volatile memory that does not erase data even if power is shut off, and the variables, such as the variable pointVer and the work-piece correction level variable workAdjVar are stored in a volatile memory that erases data when power is shut off. The point-sequence memory may be a combination of two different kinds of memories as explained above. According to this structure, it becomes possible to set a physical memory area of the point-sequence memory in view of data-writing speed or data-reading speed, and whether or not it is necessary to save data when power is shut off.

(c) According to this embodiment, it is presumed that the first and second works are executed, but the number of work instructions is not limited to two, and for example, a third work-instruction-sequence memory that stores a third work instruction may be provided, and equal to or greater than three instruction can be executed at a point.

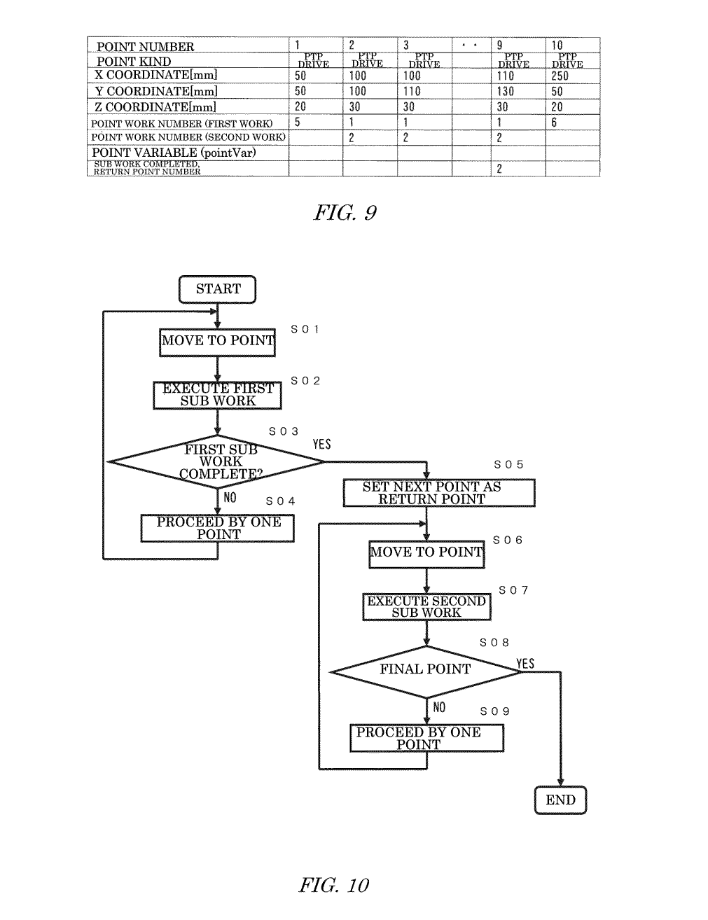

(d) As a teaching of the robot, as illustrated in FIG. 9, a return point to execute the second work after the first work completes can be set. Hence, when a work is executed at multiple points, it becomes possible to set two works at an arbitrary point. In this case, as illustrated in FIG. 10, instead of the STEP 03 in the flowchart of FIG. 7, it is determined whether or not the first work completes, and it is also determined whether to move to the next point or to move to the return point in accordance with the former determination.

(e) In addition, as a teaching of the robot, an instruction of switching the work between the first work and the second work may be provided, and an explicit switching work and a point return can be executed based on such an instruction. Hence, it becomes possible to cope with an arbitrary pattern.

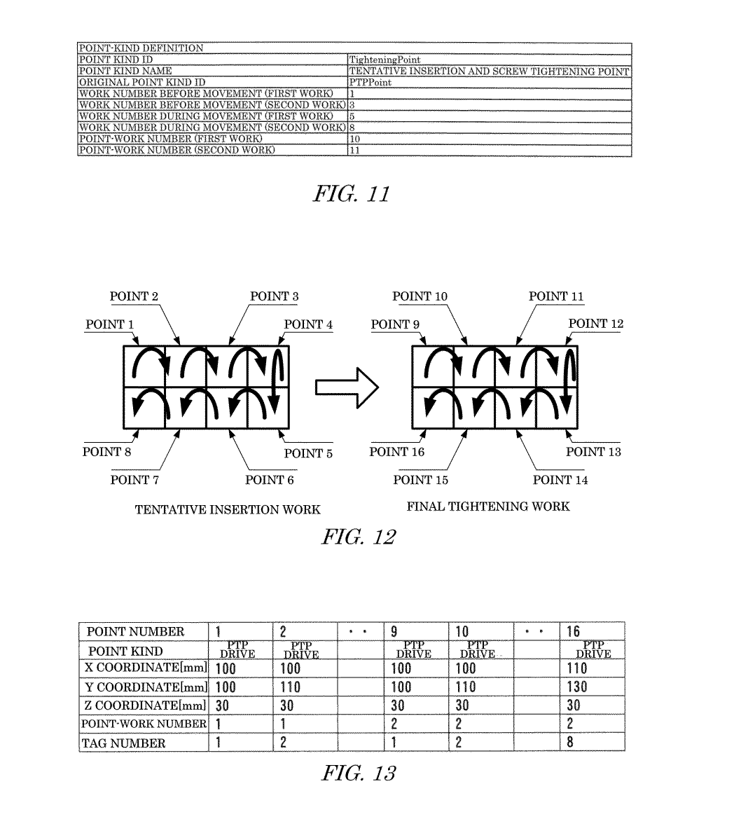

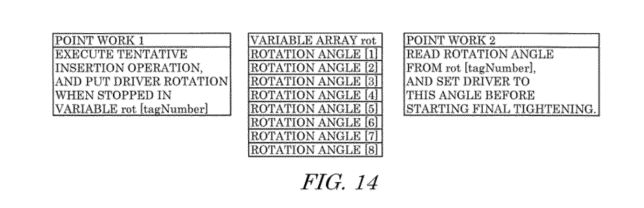

(f) As a teaching of the robot, as illustrated in FIG. 11, it is applicable when the point kind is defined. That is, in the point kind definition, two works that are the first work and the second work can be defined. In the point kind definition, in addition to a work at a point, a work before moving and a work while moving can be set. In the point kind definition, the two works that are the first work and the second work are defined in those works before moving and while moving.

What is claimed is:

1. A robot moving a work tool to a predetermined point, and executing a process specified at the point, the robot comprising:
a point position memory storing a position of the point;
a first work-instruction-sequence memory storing a first work instruction executed at the point;
a second work-instruction-sequence memory storing a second work instruction executed at the point; and
a controller moving the work tool to a position stored in the point position memory, and causing the work tool to execute the first work instruction and the second work instruction.

2. The robot according to claim 1, further comprising a variable memory storing a variable obtained upon execution of the first work instruction,
wherein when the second work instruction is executed, an instruction reflecting the variable is executed.

3. The robot according to claim 2, wherein:
the variable is a data value indicating a correction level of a position; and
when the second work instruction is executed, the controller refers to the position correction level, and moves the work tool.

4. A control method for a robot moving a work tool to a predetermined point, and executing a process specified at the point, the control method comprising:
a point position storing step for storing a position of the point;
a first work-instruction-sequence storing step for storing a first work instruction executed at the point;
a second work-instruction-sequence storing step for storing a second work instruction executed at the point where the work-piece is placed;
a step for moving the work tool to a position stored through the point storing step, and causing the work tool to execute the first work instruction and the second work instruction; and
a variable storing step for storing a variable obtained upon execution of the first work instruction,
wherein when the second work instruction is executed, an instruction reflecting the variable is executed.

5. A control program for a robot moving a work tool to points where a plurality of work-pieces are placed, respectively, and executing a process specified at the point where each work-piece is placed, the control program causing a computer controlling the robot to execute:
a point position storing step for storing a position of the point where the work-piece is placed;
a first work-instruction-sequence storing step for storing a first work instruction executed at the point where the work-piece is placed;
a second work-instruction-sequence storing step for storing a second work instruction executed at the point where the work-piece is placed;
a step for moving the work tool to a position stored through the point storing step, and causing the work tool to execute the first work instruction and the second work instruction; and
a variable storing step for storing a variable obtained upon execution of the first work instruction,
wherein when the second work instruction is executed, an instruction reflecting the variable is executed.
